(19) United States
(12) Patent Application Publication
(10) Pub. No.: US 2010/0242011 A1
(43) Pub. Date: Sep. 23, 2010

(54) METHOD FOR VERIFICATION OF MASK LAYOUT OF SEMICONDUCTOR INTEGRATED CIRCUIT

(76) Inventors: Kiyohito Mukai, Kyoto (JP); Masanori Ito, Osaka (JP); Yoshinaga Okamoto, Kyoto (JP); Seijiro Kojima, Kyoto (JP)

Correspondence Address: MCDERMOTT WILL & EMERY LLP, 600 13TH STREET, NW, WASHINGTON, DC, 20005-3096, US

(21) Appl. No.: 12/594,271

(22) PCT Filed: Feb. 17, 2009
(86) PCT No.: PCT/JP2009/000632

§ 371 Date: Oct. 1, 2009

(30) Foreign Application Priority Data
Jul. 10, 2008 (JP) 2008-180581

(51) Int. Cl. G06F 17/50

(52) U.S. Cl. 716/19

(57) ABSTRACT

In a semiconductor integrated circuit mask layout verification method, a layout pattern division condition 108, according to which a plurality of specific layout patterns that need to have identical circuit characteristics are included, is input in a condition input step 109. In a data division step 103, input mask layout design data is divided into a plurality of layout pattern groups according to the layout pattern division condition. In a standard pattern selection step 105, a standard pattern serving as a standard in pattern matching is selected for each of the divided layout pattern groups. In a pattern matching step 106, for each of the layout pattern groups, layout patterns included in that layout pattern group are compared with the standard pattern.

### TECHNICAL FIELD

The present invention relates to semiconductor integrated circuit mask layout verification methods, and more particularly relates to verification methods suitable for forming symmetric or repeated circuit patterns including fine patterns.

### BACKGROUND ART

In recent years, in order to achieve higher density semiconductor integrated circuits (LSI), minimum processing dimensions have been reduced. With this reduction, the relative proportion between the size of fine elements built into LSIs and fabrication variation occurring in the semiconductor integrated circuit fabrication process has increased, causing variation in circuit characteristics to begin to present a problem.

For example, it is important for two transistors forming a differential amplifier to have symmetry in circuit configuration as well as to have symmetry in their shape, characteristics, and variation on a silicon wafer. Thus, a mask layout of the two transistors forming a differential amplifier is designed with consideration given to their shapes and locations and to their relation with the surrounding patterns from the mask layout designing stage.

In verifying whether the mask layout of the two transistors of a differential amplifier has actually been performed taking their shapes, locations, and relation with the surrounding patterns into consideration, conventional DRC (Design Rule Check) cannot confirm sufficiently whether these requirements are satisfied.

Hence, conventional techniques used to verify symmetry or pattern matching include pattern matching techniques, in which a mask layout is searched for patterns of the same shape or patterns satisfying the same condition. These pattern matching techniques have been widely used in the field of semiconductor inspection equipment.

The technique described in Patent Document 1 is known as a conventional pattern matching technique. In this pattern matching technique, a pattern (referred to as a “template” or “standard”), with which a match is to be searched for, and search steps are determined in advance, and a search is repeatedly performed in those search steps by slightly shifting the search region, thereby detecting applicable patterns.

### Patent Document 1: Japanese Laid-Open Publication No. 2005-061837

### DISCLOSURE OF THE INVENTION

### Problems that the Invention Intends to Solve

As described above, for example, two transistors forming a differential amplifier are required to have symmetry not only in circuit configuration, but also in mask layout shape, device location, and mask layout pattern around the devices in order to ensure the operation characteristics of the differential amplifier.

However, in the conventional pattern matching technique, the accuracy of pattern matching is determined by how detailed search steps are, that is, by the number of repetitions performed in the search. Thus, when the search steps are detailed, the accuracy of pattern matching increases, while a disadvantage arises in that the search takes a long time. In particular, in the case of mask data of memory products, etc. which contain many repetitive patterns, efficient pattern matching is achieved in which resultant accuracy and processing time are both favorable. However, in the case of logic circuits in which layout patterns are not repeated very much, the efficiency of pattern matching is lowered, and problems occur in that no applicable patterns are detected, and the processing time increases enormously.

The conventional technique has further drawbacks: In the case of mask patterns of the same shape, for example, transistors of the same shape, having circuit configurations in which wiring is connected differently, if templates are prepared in advance with the wiring excluded, all patterns are considered to be the same in pattern matching operation because the transistors have the same shape. On the other hand, if templates are prepared in advance with the wiring included, all patterns are considered to be different in pattern matching operation because of the different configurations of the wiring. In particular, in a differential circuit in which influences of variation in circuit characteristics should be suppressed, a pair of identical transistors are used, however, these transistors have different wiring configurations in many cases. Thus, it is not easy to identify that these transistors make a pair.

Moreover, in the conventional technique, templates should be prepared in advance. When there are a plurality of pairs, templates cannot be prepared until how many types of pairs are present is known, and it is also difficult to prepare numerous types of templates.

To solve the above-described problems, it is an object of the present invention to perform pattern matching in a short search time with high matching efficiency without preparing a template in advance.

### Means for Solving the Problems

In order to achieve the object, according to the present invention, the entire mask layout design data of a semiconductor integrated circuit is not searched for patterns that match a single layout pattern. Instead, the mask layout design data is divided into many layout pattern groups in such a manner that each layout pattern group includes, for example, layout patterns of two transistors that make a pair in a specific differential circuit, that is, specific layout patterns that should have the same circuit characteristics. Pattern matching is then individually performed for each of the layout pattern groups by searching each layout pattern group. A standard pattern (a template) used in pattern matching is automatically generated for each of the layout pattern groups according to a given standard.

Specifically, an inventive semiconductor integrated circuit mask layout verification method includes, in semiconductor integrated circuit layout design using a computer, a data input step of reading mask layout design data into the computer; a condition input step of inputting a layout pattern division condition so that a plurality of specific layout patterns that need to have identical circuit characteristics are included; a data division step of dividing the mask layout design data read in the data input step into a plurality of layout pattern groups according to the layout pattern division condition input in the condition input step; a standard pattern selection step of selecting a standard pattern serving as a standard in pattern matching for each of the layout pattern groups divided in the data division step; and a pattern matching step of comparing, for each of the layout pattern groups divided in the data division step, layout patterns included in that layout pattern group with the standard pattern selected in the standard pattern selection step.

In the inventive semiconductor integrated circuit mask layout verification method, in the condition input step, the input layout pattern division condition is a mask shape in the mask layout design data read in the data input step.

In the inventive semiconductor integrated circuit mask layout verification method, in the condition input step, the input layout pattern division condition is information concerning connections between semiconductor integrated circuit devices indicated in the mask layout design data read in the data input step.

In the inventive semiconductor integrated circuit mask layout verification method, in the data division step, the layout pattern groups divided according to the mask shape in the mask layout design data are output, the mask shape being input in the condition input step.

In the inventive semiconductor integrated circuit mask layout verification method, in the data division step, the layout pattern groups divided according to the information concerning the connections between the semiconductor integrated circuit devices indicated in the mask layout design data are output, the information being input in the condition input step.

In the inventive semiconductor integrated circuit mask layout verification method, in the standard pattern selection step, the standard pattern is individually selected from each of the layout pattern groups divided in the data division step according to a predetermined selection standard.

In the inventive semiconductor integrated circuit mask layout verification method, in the pattern matching step, comparison processing is performed with other patterns included in the standard pattern selected in the standard pattern selection step, the other patterns being obtained by rotation of, vertical flipping of, horizontal flipping of, and both vertical and horizontal flipping of the standard pattern.

In the inventive semiconductor integrated circuit mask layout verification method, in the pattern matching step, the layout patterns included in each layout pattern group are compared with the standard pattern selected in the standard pattern selection step, and the layout pattern group is also compared with a pattern that is present in a predetermined area surrounding the standard pattern.

In the inventive semiconductor integrated circuit mask layout verification method, in the standard pattern selection step, the predetermined selection standard is a standard according to which a layout pattern closest to the origin point (0, 0) of a data coordinate system of each layout pattern group is selected as the standard pattern.

As described above, according to the present invention, the read mask layout design data is divided into the layout pattern groups in accordance with the layout pattern division condition input in the condition input step. This layout pattern division condition is, for example, mask shapes that indicate diffusion layers of transistors, or information concerning connections of circuit elements, such as a specific signal wiring, power wiring, and ground wiring, that are connected to gate, source, and drain of each transistor. For example, for two transistors that make a pair in a differential circuit, the same diffusion layer may be used, and a signal wiring, etc. to be connected may be a common signal wiring, etc. Hence, there is a high possibility that the divided layout pattern groups each include specific layout patterns that should have the same circuit characteristics. Therefore, if pattern matching is performed for each of the divided layout pattern groups by searching each layout pattern group, the search time is reduced significantly, and the efficiency of the pattern matching is increased.

Furthermore, in the standard pattern selection step, one of the layout patterns included in each of the divided layout pattern groups is selected as a standard pattern used in pattern matching for that layout pattern group, thereby eliminating the need for preparing templates (standards) in advance.

### Effects of the Invention

As described above, according to the inventive semiconductor integrated circuit mask layout verification method, layout patterns that include an object (a semiconductor device) to be detected in pattern matching and combinations thereof are grouped together in a single layout pattern group in accordance with a condition given in advance. It is thus possible to verify in a short search time with high pattern matching efficiency whether or not the two or more layout patterns that should have the same circuit characteristics are so laid out. This effect is not achievable by methods in which layout patterns as physical location information are deleted to extract only circuit information, such as LVS (Layout VS Schematic) and LPE (Layout Parasitic Extraction) for extracting semiconductor devices and net lists.

Moreover, unlike in the conventional technique, there is no need to prepare templates or standards in advance, and it is thus not necessary to know beforehand how many types of pairs of transistors of different shapes are present, for example.

### BRIEF DESCRIPTION OF DRAWINGS

FIG. 1 is a flowchart showing a semiconductor integrated circuit mask layout verification method according to a first embodiment of the invention.

FIG. 2(a) is a layout chart showing a portion of read mask layout design data, and

FIGS. 2(b) and 2(c) show layout pattern groups divided in a data division step.

FIGS. 3(a) and 3(b) show the layout pattern groups divided in the data division step, and FIGS. 3(c) and 3(d) show a given selection standard according to which a standard pattern is selected from the layout pattern group.

FIGS. 4(a) to 4(h) show variations of a pattern matching standard pattern.

FIG. 5 is a layout chart showing an example of mask layout design data read in a second embodiment of the invention.

FIGS. 6(a) and 6(b) show layout pattern groups obtained by dividing the mask layout design data of FIG. 5 in a data division step according to a division condition, which is circuit connection information.

FIG. 7 shows an example layout in a case in which a layout pattern group is compared with a standard pattern which also includes patterns obtained by rotation of, vertical flipping of, horizontal flipping of, and both vertical and horizontal flipping of the standard pattern.

FIGS. 8(a) and 8(b) show an example comparison processing in which comparison is made in a region including a standard pattern and a predetermined area surrounding the standard pattern.

### EXPLANATION OF THE REFERENCE CHARACTERS

101 Mask layout design data

102 Data input step

103 Data division step

104 Layout pattern group

105 Standard pattern selection step

106 Pattern matching step

107 Comparison results

108 Layout data division condition

109 Condition input step

207, 208 Signal wiring

210-214, 301-305 Layout pattern

220, 221, 308, 309 Layout pattern group

306, 307 Diffusion layer

305, 501-508 Standard pattern

310-312, 401, 402 Layout pattern

405, 406 Region including a surrounding area

### DETAILED DESCRIPTION OF THE INVENTION

Hereinafter, embodiments of the present invention will be described with reference to the accompanying drawings.

### First Embodiment

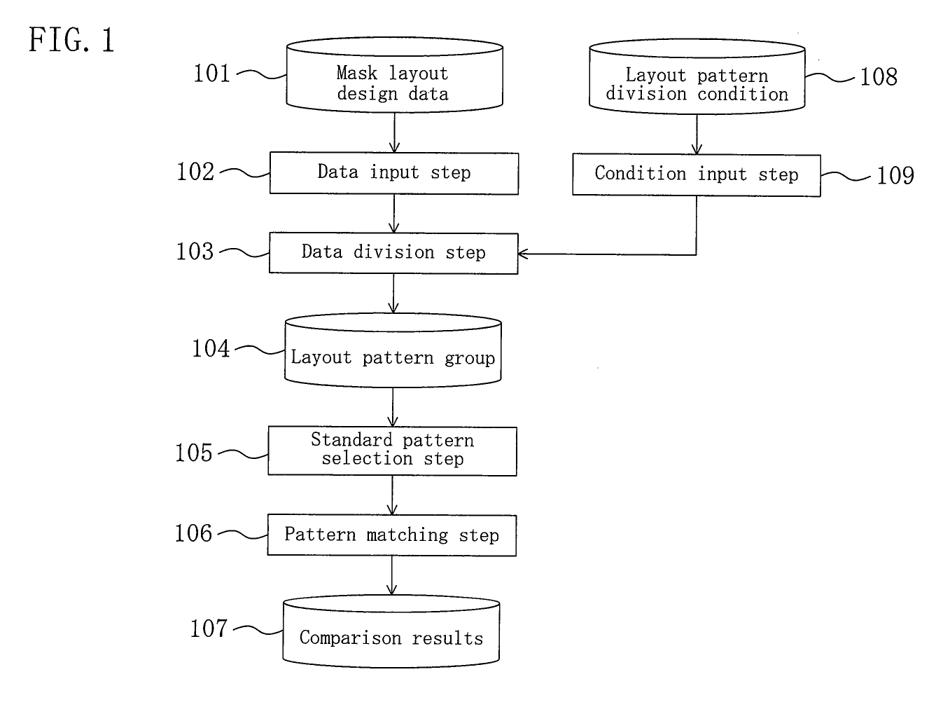

FIG. 1 is a flowchart of a semiconductor integrated circuit mask layout verification method using a computer according to a first embodiment of the present invention.

In FIG. 1, mask layout design data 101 is first read in a data input step 102. Next, a layout pattern division condition 108 is read in a condition input step 109.

Then, in a data division step 103, the mask layout design data 101 read in the data input step 102 is divided into layout pattern groups according to the layout pattern division condition 108 read in the condition input step 109, and the layout pattern groups 104 are output.

Subsequently, in a standard pattern selection step 105, a standard pattern is individually selected from each of the divided layout pattern groups 104 as a standard used in pattern matching performed for layout patterns included in that layout pattern group 104.

Then, in a pattern matching step 106, comparisons (e.g., pattern matching) are made between the layout patterns included in each of the layout pattern groups 104 and the standard pattern selected from that layout pattern group, thereby obtaining comparison results 107.

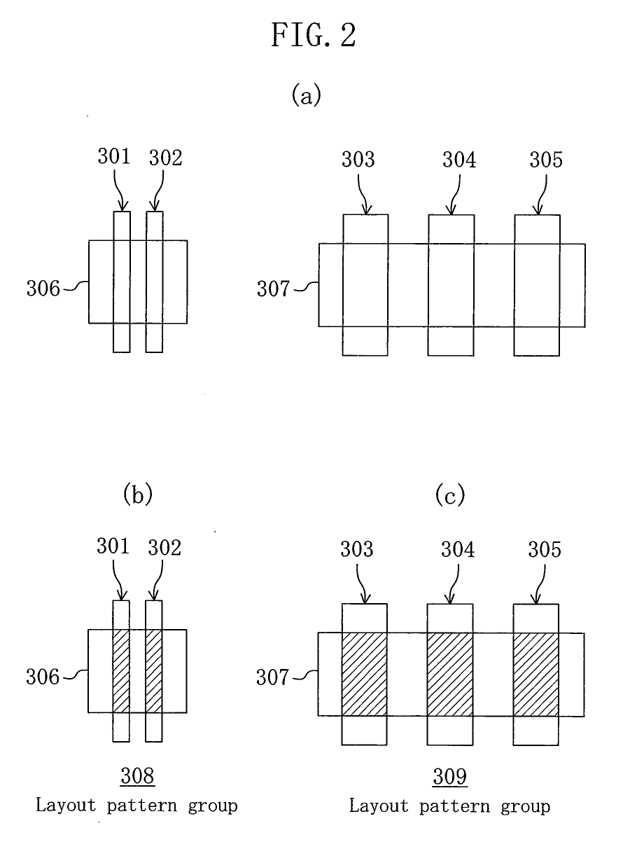

A specific example of the layout pattern division condition 108 in the condition input step 109 will be given. The layout pattern division condition 108 read in the condition input step 109 corresponds, e.g., to the shapes of transistors, and specifies diffusion layers (mask shapes) of the transistors, for example. More specifically, as shown in FIG. 2(a), suppose a case in which five transistors 301 to 305 are present in a portion of the read mask layout design data 101, and diffusion layers 306 and 307 are specified as the layout pattern division condition 108. In this case, in the data division step 103, division is made in such a manner that the two transistors 301 and 302 belonging to the same diffusion layer 306 are included in a layout pattern group 308 as shown in FIG. 2(b), and the three transistors 303 to 305 belonging to the other diffusion layer 307 are included in a layout pattern group 309 as shown in FIG. 2(c). The layout patterns (301 and 302) belonging to the layout pattern group 308 are often formed using the same diffusion layer so as to have the same circuit characteristics, and so are the layout patterns (303, 304, and 305) belonging to the layout pattern group 309. This enables pattern matching for each of the layout pattern groups 308 and 309 thus divided to be efficiently performed.

In the specific example described above, the layout pattern groups 104 obtained in the data division step 103 are data containing the two layout pattern groups 308 and 309. In this way, when mask shapes in the mask layout design data are specified as the layout pattern division condition 108, graphical pattern searches are performed.

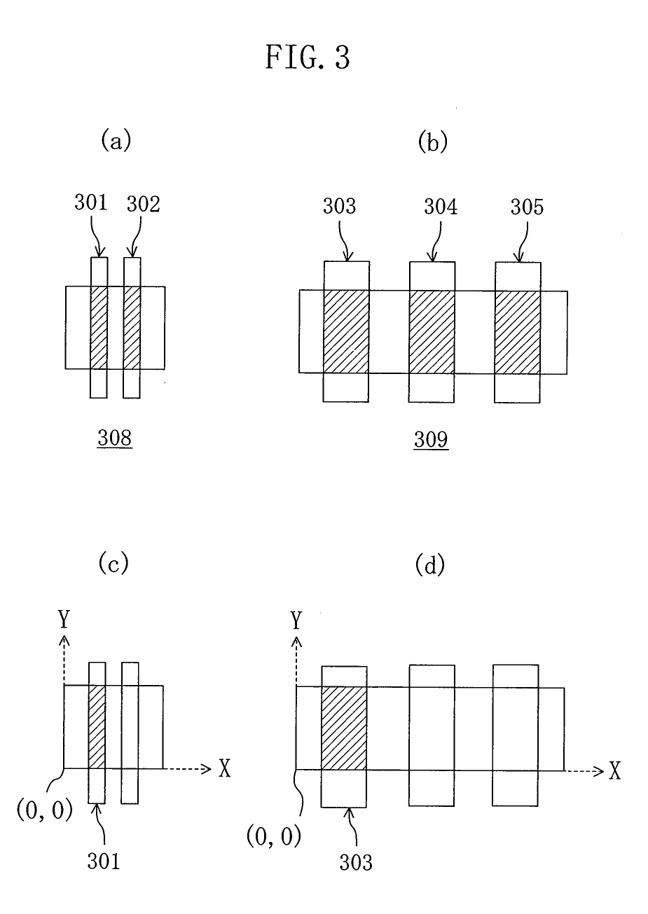

Next, a specific example of the standard pattern selection step 105 will be discussed. In the standard pattern selection step 105, a layout pattern, for example, closest to the origin point (0, 0) of the coordinate system of each of the layout pattern groups divided in the data division step 103 is selected as a standard pattern. Specific description will be given with reference to FIG. 3. FIGS. 3(a) and 3(b) show the layout pattern groups 308 and 309 divided in the data division step 103. The layout pattern group 308 of FIG. 3(a) includes the two transistor layout patterns 301 and 302, and the transistor layout pattern 301 closest to the origin point (0, 0) of the coordinate system of the layout pattern group 308 is selected as the standard pattern as shown in FIG. 3(c). The layout pattern group 309 of FIG. 3(b) includes the three transistor layout patterns 303 to 305, and the transistor layout pattern 303 closest to the origin point (0, 0) of the coordinate system of the layout pattern group 309 is selected as the standard pattern as shown in FIG. 3(d).

In the pattern matching step 106 shown in FIG. 1, the layout patterns belonging to each layout pattern group 104 are compared with the standard pattern selected from that layout pattern group, thereby performing pattern matching for each of the obtained layout pattern groups 104. For example, in the layout pattern group 308 of FIG. 3(a), it is determined that the transistor layout pattern 302 matches the standard pattern 301. In the layout pattern group 309 of FIG. 3(b), it is determined that the transistor layout patterns 304 and 305 match the standard pattern 303.

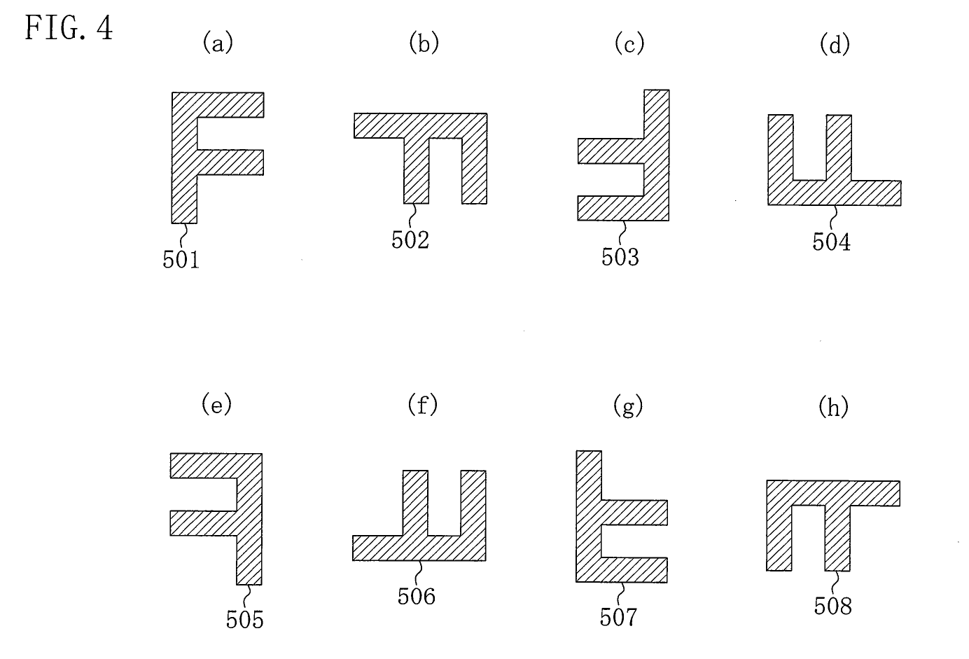

In this embodiment, in the pattern matching step 106, pattern matching is performed using not only the shape of the selected standard pattern, but also various variations thereof For example, in a case in which a standard pattern 501 having the shape of the English character “F” is selected as shown in FIG. 4(a), pattern matching is performed using not only the standard pattern but also variations thereof, which are the shapes obtained by sequentially rotating the shape “F” by an angle of 90° clockwise as shown in FIGS. 4(b) to 4(d), the shape obtained by horizontally flipping the English character “F” as shown in FIG. 4(e), and the shapes obtained by sequentially rotating the horizontally flipped “F” by an angle of 90° clockwise as shown in FIGS. 4(f) to 4(h).

### Second Embodiment

Next, a second embodiment of the present invention will be described.

In the first embodiment, in the data division step 103, data division depending on mask shapes has been described by way of example. In this embodiment, mask layout design data is divided according to circuit connection information.

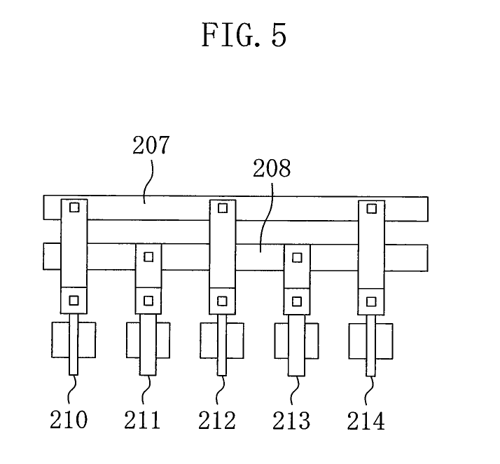

FIG. 5 shows mask layout design data according to this embodiment. In this design data, layout patterns 210, 212, and 214 of three transistors connected to a signal wiring 207, and layout patterns 211 and 213 of two transistors connected to a signal wiring 208 are present.

In this embodiment, the layout pattern division condition 108 in the condition input step 109 is circuit connection information. For example, in the mask layout design data of FIG. 5, the signal wiring 207 or 208 is specified as the circuit connection information.

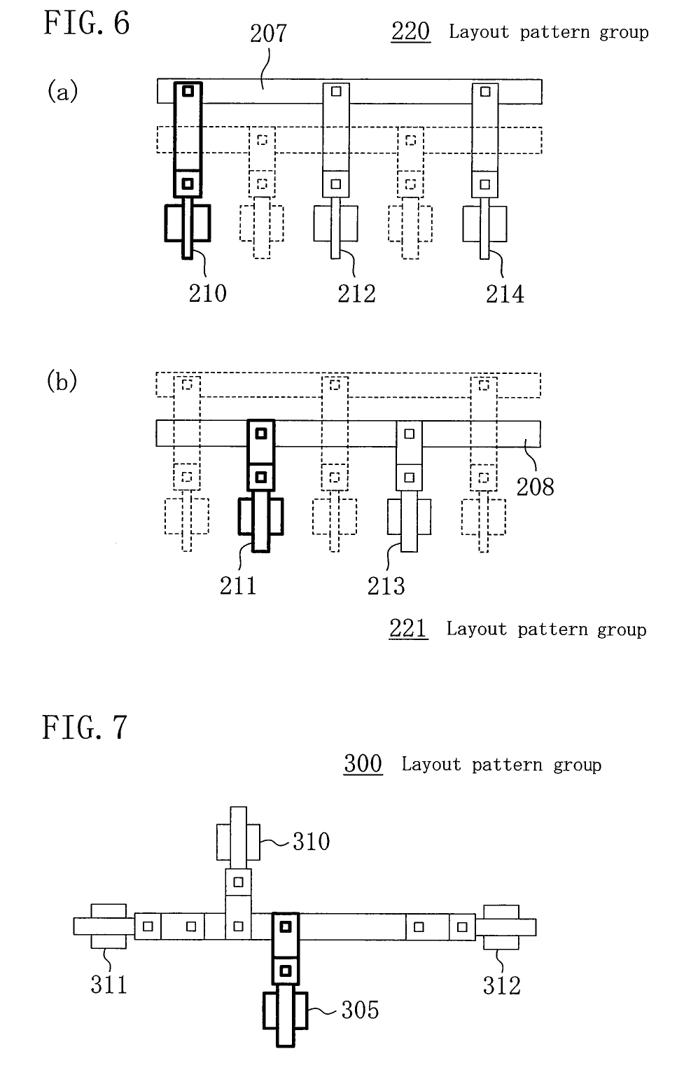

When the layout pattern division condition 108 in the condition input step 109 is the signal wiring 207, the layout pattern group 104 obtained in the data division step 103 is a layout pattern group 220 including this signal wiring 207 and the layout patterns 210, 212, and 214 of the three transistors connected with the signal wiring 207 as shown in FIG. 6(a). When the layout pattern division condition 108 in the condition input step 109 is the signal wiring 208, the layout pattern group 104 obtained in the data division step 103 is a layout pattern group 221 including this signal wiring 208 and the layout patterns 211 and 213 of the two transistors connected with the signal wiring 208 as shown in FIG. 6(b). In FIGS. 6(a) and 6(b), the layout patterns 210 and 211 of the transistors that are closest to the respective origin points (0, 0) of the coordinate systems of the layout pattern groups 220 and 221 are selected as the standard patterns. In FIGS. 6(a) and 6(b), the thick solid lines indicate these standard patterns.

In this manner, when mask layout design data is divided according to circuit connection information, pattern searches depending on both circuit configuration and mask layout are performed.

Also, as shown in FIG. 7, as in the first embodiment, when a standard pattern 305 is selected from an obtained layout pattern group 300, pattern matching is performed using not only the standard pattern but also the shapes obtained by rotating the standard pattern 305 through angles of 90°, 180°, and 270° clockwise, the shape obtained by horizontally flipping the standard pattern 305, the shapes obtained by rotating the horizontally flipped shape through angles of 90°, 180°, and 270°, the shape obtained by vertically flipping the standard pattern 305, and the like. In this pattern matching, the pattern 310 obtained by vertically flipping the standard pattern 305, the pattern 311 obtained by rotating the standard pattern 305 through an angle of 90° clockwise, and the pattern 312 obtained by rotating the standard pattern 305 through an angle of 270° clockwise are identifiable as the same patterns.

### Third Embodiment

Next, a third embodiment of the present invention will be described.

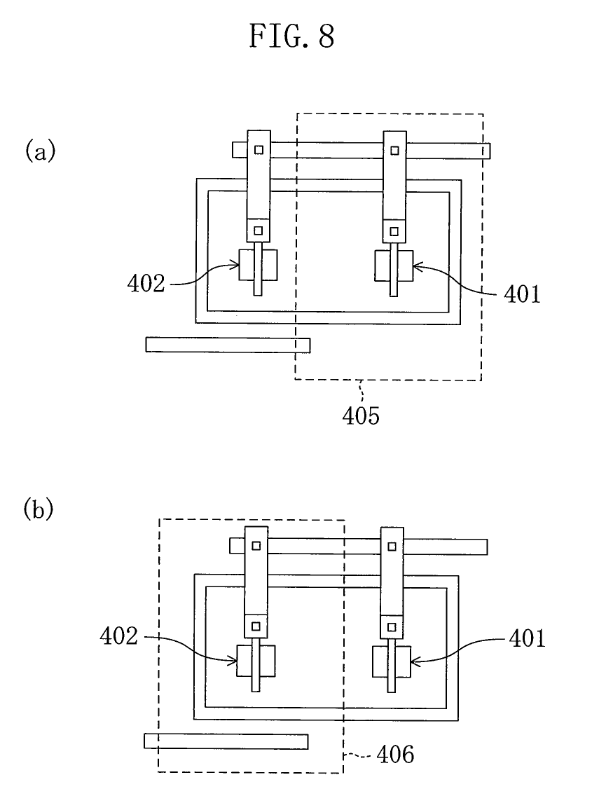

In the first embodiment, a layout pattern closest to the origin point (0, 0) of the coordinate system of each of the divided layout pattern groups is selected as a standard pattern in the standard pattern selection step 105. In this embodiment, regions 405 and 406 that include layout patterns located around standard patterns 401 and 402 are entirely selected as standard patterns as shown in FIGS. 8(a) and 8(b).

In FIGS. 8(a) and 8(b), when compared with each other, the layout patterns 401 and 402 of two transistors have the same shape, however, the regions 405 and 406 that include the areas surrounding these layout patterns 401 and 402 have different shapes. In a case in which the layout patterns 401 and 402 are composed of transistors (semiconductor devices), the device characteristics may vary depending not only on the shapes of the semiconductor devices, but also on the effects of the layout patterns surrounding those semiconductor devices. Thus, it is necessary to verify shape matching with the regions 405 and 406 including those surrounding areas. If the regions 405 and 406 including the surrounding areas are defined more largely, shape matching can be verified more accurately, while the time required for searching for layout patterns that match in shape will increase very much. Therefore, if the layout pattern search is performed with the transistor layout patterns (the standard patterns in the narrow sense) 401 and 402 used as the initial values, the range of the search and the amount of processing in the search are reduced.

In the example cases discussed in the foregoing description, the mask layout design data is divided according to the mask shapes or the circuit connection information.

Nevertheless, data division may be performed with other attributes of semiconductor integrated circuit devices used as standards, such as type, size, resistance value, transistor gate length and gate width, and the amount of current that can be passed through the device.

### INDUSTRIAL APPLICABILITY

As described above, according to the present invention, it is possible to verify that mask layouts of semiconductor integrated circuits have been designed as desired with increased verification accuracy and in a shorter verification time despite increased fabrication variation and reduced design margin resulting from finer design patterns and denser circuits achieved in semiconductor integrated circuit fabrication process. In particular, the present invention is able to provide methods for comprehensively utilizing semiconductor pattern mask layout design data and circuit diagrams that are managed as CAD data, and other pieces of data used in mask layout pattern design.

1. A method for verification of mask layout of semiconductor integrated circuit using a computer, the method comprising,
a data input step of reading mask layout design data into the computer;
a condition input step of inputting a layout pattern division condition so that a plurality of specific layout patterns that need to have identical circuit characteristics are included;
a data division step of dividing the mask layout design data read in the data input step into a plurality of layout pattern groups according to the layout pattern division condition input in the condition input step; and
a pattern matching step of comparing, for each of the layout pattern groups divided in the data division step, layout patterns included in that layout pattern group with a standard pattern serving as a standard in pattern matching.

2. The method for verification of mask layout of semiconductor integrated circuit of claim 1, wherein in the condition input step, the layout pattern division condition to be input is a mask shape in the mask layout design data read in the data input step.

3. The method for verification of mask layout of semiconductor integrated circuit of claim 1, wherein in the condition input step, the layout pattern division condition to be input is information concerning connections between semiconductor integrated circuit devices indicated in the mask layout design data read in the data input step.

4. The method for verification of mask layout of semiconductor integrated circuit of claim 2, wherein in the data division step, the layout pattern groups divided according to the mask shape in the mask layout design data are output, the mask shape being input in the condition input step.

5. The method for verification of mask layout of semiconductor integrated circuit of claim 3, wherein in the data division step, the layout pattern groups divided according to the information concerning the connections between the semiconductor integrated circuit devices indicated in the mask layout design data are output, the information being input in the condition input step.

6. The method for verification of mask layout of semiconductor integrated circuit of claim 10, wherein in the standard pattern selection step, the standard pattern is individually selected from each of the layout pattern groups divided in the data division step based on a predetermined selection standard.

7. The method for verification of mask layout of semiconductor integrated circuit of claim 1, wherein in the pattern matching step, comparison processing is performed with other patterns as other standard patterns, the other patterns being obtained by rotation of, vertical flipping of, horizontal flipping of, and both vertical and horizontal flipping of the standard pattern.

8. The method for verification of mask layout of semiconductor integrated circuit of claim 1, wherein in the pattern matching step, the layout patterns included in each layout pattern group are compared with the standard pattern, and the layout pattern group is also compared with a pattern that is present in a predetermined area surrounding the standard pattern.

9. The method for verification of mask layout of semiconductor integrated circuit of claim 6, wherein in the standard pattern selection step, the predetermined selection standard is a standard according to which a layout pattern closest to the origin point (0, 0) of a data coordinate system of each layout pattern group is selected as the standard pattern.

10. The method for verification of mask layout of semiconductor integrated circuit of claim 1, further comprising a standard pattern selection step of selecting the standard pattern.
